(19) United States
(12) Patent Application Publication
(10) Pub. No.: US 2025/0245565 A1
(43) Pub. Date: Jul. 31, 2025

(54) CROSS-CLUSTER COMMUNICATION FOR MACHINE LEARNING WORKLOADS

(71) Applicant: Google LLC, Mountain View, CA (US)

(72) Inventors: Aakanksha Chowdhery, Mountain View, CA (US); Paul Ronald Barham, San Francisco, CA (US)

(21) Appl. No.: 18/853,331

(22) PCT Filed: Apr. 3, 2023
(86) PCT No.: PCT/US2023/017337

§ 371 Date: Oct. 1, 2024

Related U.S. Application Data
(60) Provisional application No. 63/326,758, filed on Apr. 1, 2022.

(51) Int. Cl. G06N 20/00; G06F 9/48

(52) U.S. Cl. CPC G06N 20/00; G06F 9/4881

(57) ABSTRACT

Methods, systems, and apparatus, including computer programs encoded on computer storage media, for distributing machine learning workloads across hardware accelerators. One of the systems comprises a first plurality of hardware accelerators that are interconnected over a first network and one or more corresponding hosts for the first plurality of hardware accelerators; and a second plurality of hardware accelerators that are interconnected over a second network and one or more corresponding hosts for the second plurality of hardware accelerators, wherein the corresponding hosts for the first and second pluralities of hardware accelerators are connected over a third network. For example, the first and second network can each be a respective Inter-Core Interconnect (ICI) network, while the third network can be a data center network, e.g., an Ethernet network.

### CROSS-REFERENCE TO RELATED APPLICATION

This application claims priority to U.S. Provisional Application No. 63/326,758, filed on Apr. 1, 2022. The disclosure of the prior application is considered part of and is incorporated by reference in the disclosure of this application.

### BACKGROUND

This specification relates to training machine learning models, including neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters.

### SUMMARY

This specification describes techniques for improving the network throughput of two or more clusters of hardware accelerators. Hardware accelerators (or “accelerators” for short) are computing devices having specialized hardware configured to perform specialized computations including, e.g., machine learning computations. Examples of accelerators include graphics processing units (“GPUs”), field-programmable gate arrays (“FGPAs”), and application-specific integrated circuits (“ASICs”), including tensor processing units (“TPUs”).

The hardware accelerators within each cluster are interconnected with one another over an interconnect network, and are connected to the hardware accelerators within another cluster over a data center network through their corresponding hosts. In some implementations, the two or more clusters of hardware accelerators are subsets of a larger cloud-based computing system comprising many, possibly thousands, of hardware accelerators. In some implementations, the two or more clusters of hardware accelerators are physically adjacent to one another, e.g., located within a same data center, while in other implementations, the two or more clusters of hardware accelerators are physically remote from one another, e.g., located across different data centers. In some implementations, the two or more clusters of hardware accelerators and their corresponding hosts are used to collectively support machine learning workloads, e.g., computations for training a neural network or computing an inference using a neural network.

Particular embodiments of the subject matter described in this specification can be implemented so as to realize one or more of the following advantages.

The cross-cluster data communication techniques described herein can be used to ensure resource efficiency in supporting machine learning workloads across two or more clusters of interconnected hardware accelerators. Such techniques can optimize cross-cluster communication over data center networks, which in turn improves the scalability and manageability of ultra-large-scale machine learning workloads. For example, using the described techniques to train a large-scale neural network can achieve a near-perfect, 1.95 times higher training throughput across two clusters of hardware accelerators that are connected through a data center network, relative to the training throughput on a single cluster of hardware accelerators.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for executing a machine learning workload.

FIG. 2 is an example illustration of training a machine learning model on multiple clusters of hardware accelerators using data and model parallelism.

FIG. 3 is a flow diagram of an example process for training a machine learning model on multiple clusters of hardware accelerators.

FIG. 4 is a flow diagram of an example process for updating parameters of a machine learning model during the training.

Like reference numbers and designations in the various drawings indicate like elements.

### DETAILED DESCRIPTION

This specification describes a system implemented as computer programs on one or more computers in one or more locations that executes a machine learning workload using multiple hardware accelerators and their corresponding hosts.

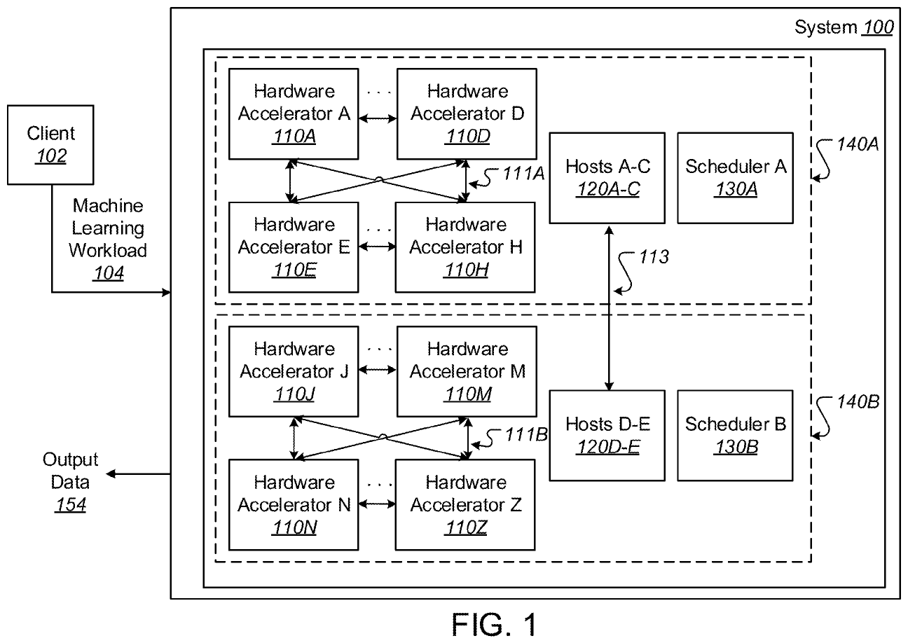

FIG. 1 illustrates an example system 100 for executing a machine learning workload 104. The machine learning workload 104 can be specified by a client 102. The system 100 can receive data specifying the machine learning workload 104 from the client 102, and generate output data 154 as a result of the execution of the machine learning workload 104. In some implementations, the data specifying the machine learning workload 104 may include source programs written in Python programming language by using appropriate Python programming frameworks such as TensorFlow and JAX, while in other implementations, the data may alternatively include source programs written in another high-level programming language, such as C++ language.

In some implementations, the machine learning workload 104 may include computations for training a neural network, or computing an inference using a neural network. The neural network has a set of parameters. The neural network can generally be configured, i.e., through training, to perform a machine learning task by processing a network input in accordance with the parameters to generate one or more network outputs for the machine learning task.

The neural network can have any appropriate architecture that allows the neural network to receive network inputs of the type required by the machine learning task and to generate network outputs of the form required for the task. Examples of the neural network include fully-connected neural networks, convolutional neural networks, recurrent neural networks, attention-based neural networks, e.g., Transformers, and so on. Some such example neural networks are large-scale neural networks. A large-scale neural network is a neural network with many network parameters, e.g., 1 billion parameters, 10 billion parameters, 100 billion parameters, or 500 billion or more parameters.

It should be noted that, although the techniques described in this specification are largely described with reference to a neural network, the techniques can be similarly applied to other machine learning models, including a Naïve Bayes model, a Support Vector Machine model, a linear regression model, a logistic regression model, or a k-nearest neighbor model, to name just a few examples.

Some examples of machine learning tasks that the neural network can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input and the output is a sequence of intensity value inputs for the pixels of an image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the task is a multi-modal task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In the implementations where the system 100 executes the machine learning workload 104 for training a neural network, the system 100 can receive architecture data defining an architecture of the neural network. The architecture defines the number of layers in the neural network, the operations performed by each of the layers, and the connectivity between the layers in the neural network, i.e., which layers receive inputs from which other layers in the neural network.

The system 100 can also receive training data for training the neural network to perform one or more of the machine learning tasks mentioned above. Generally, the training data includes a set of neural network inputs and, for each network input, a respective target output that should be generated by the neural network to perform the particular task. In some implementations, a larger set of training data may be randomly partitioned by the system to generate the training data and a validation set for evaluating the performance of the neural network on the tasks.

The system 100 can receive the architecture data and training data in any of a variety of ways. For example, the system 100 can receive the architecture data as an upload from the client 102 over the data communication network, e.g., using an application programming interface (API) made available by the system 100. As another example, the system 100 can receive an input from the client 102 specifying which data that is already maintained by the system 100, or another cloud storage system that is accessible by the system, should be used for training the neural network.

Once the system 100 trains the neural network through the execution of machine learning workload 104, the system can provide data specifying the trained neural network for use in processing new network inputs. That is, the system can output the trained values of the network parameters to the client 102 for later use in processing inputs using the trained neural network, e.g., by outputting to a user device or by storing in a memory accessible to the system.

Alternatively or in addition to outputting the trained neural network data, the system 100 can instantiate an instance of the neural network having the trained values of the network parameters, and receive inputs to be processed and use the trained neural network to process the received inputs to generate outputs and then provide the generated outputs in respect to the received inputs. The system can receive network inputs through an application programming interface (“API”) offered by the system. The trained neural network can be used to perform any of a variety of machine learning tasks, e.g., one of the tasks described above.

The system 100 is typically hosted within a data center, which can be a distributed, cloud-based computing system having hundreds or thousands of hardware accelerators, e.g., hardware accelerator A 110A-hardware accelerator Z 110Z, in one or more locations. Hardware accelerators (or “accelerators” for short) are computing devices having specialized hardware configured to perform specialized computations including, e.g., machine learning computations. Examples of accelerators include graphics processing units (“GPUs”), field-programmable gate arrays (“FGPAs”), and application-specific integrated circuits (“ASICs”), including tensor processing units (“TPUs”).

Because the hardware accelerators can only efficiently perform a subset of operations, e.g., matrix multiplication, for which their hardware is optimized, the hardware accelerators are connected to host machines, e.g., hosts A-C 120A-C and hosts D-E 120D-E, which may be CPU-based host machines, to perform operations that cannot be executed on the hardware accelerators efficiently. The host machines (or “hosts” for short) are generally responsible for operations including loading data from cloud storage, preprocessing data, sending data to the hardware accelerators, and the like. In some implementations, each accelerator has a distinct host while in other implementations, two or more of the accelerators can share a host.

Each host manages an object store which can store the inputs and outputs of computation performed on the corresponding hardware accelerator(s). The object store can also track the data buffers held in memories of the hardware accelerators. For example the client can use opaque handles to reference objects in a remote host or accelerator memory that allows the system to migrate objects if needed. The object store can also store intermediate program values, for example while the system is waiting to transfer them between accelerators, or pass them to a subsequent computation.

Each host instantiates an executor which can dispatch, i.e., schedule the execution of, the respective portions of the machine learning workload 104 across the hardware accelerators. The executions are scheduled in parallel when possible, for example by using multiple CPU cores or GPU streams. For example, the executor can be a CPU-based TensorFlow executor that facilitates serialization of input processing into a dataflow graph that represents the machine learning workload.

While FIG. 1 illustrates one client 102, the system 100 can execute the computation on behalf of many clients. In other words, the system 100 can receive respective data specifying different machine learning workloads from two or more clients, execute the different workloads with at least some degree of concurrency, and generate respective output data as a result of the execution of the different machine learning workloads. Each client can be physically adjacent to the system 100, e.g., located within a same data center as (some parts of) the system 100, or can alternatively be a cloud client that is remote from the system 100. In the latter case, the system 100 can be at least partially controlled by the cloud client. Each client can run, for example, on a desktop computer, a laptop computer, a tablet computer, a wearable computer, a cellular phone, a smart phone, a music player, an e-book reader, a navigation system, or any other appropriate computing device. Each client can communicate with the system 100 over a data communication network.

The system 100 uses a resource manager to maintain, i.e., generate or update, data that specifies the partitioning of the hardware accelerators and their corresponding hosts into a plurality of clusters. The resource manager is responsible for the centralized management of the devices, including the hardware accelerators, hosts, and schedulers, across all of the clusters. The resource manager can track all available devices of the system 100, and thus allowing underlying compute resources to be added and removed dynamically to the system.

In some implementations, the resource manager can adopt a simple heuristic algorithm that attempts to statically balance load by spreading computations across all available devices. In other implementations, the resource manager can adopt a more sophisticated allocation algorithm, for example taking into account the resource requirements of all client computations and the current state of the system to approximate an optimal allocation of physical devices to computations.

In some implementations, all of the accelerators in the system 100 are the same type of accelerator while in other implementations different clusters can include different types of accelerators or a single cluster can include multiple different types of accelerators. In some implementations, the partitioning is static while, in other implementations, the resource manager dynamically adjusts the partitioning based on the current system workload.

Each cluster includes a plurality of accelerators and their corresponding hosts. For example, as illustrated in FIG. 1, the system 100 maintains data partitioning hardware accelerators and their corresponding hosts into two clusters 140A-B, where the cluster 140A includes hardware accelerator A 110A—hardware accelerator H 110H and hosts A-C 120A-C, while the cluster 140B includes hardware accelerator J 110J—hardware accelerator Z 110Z and hosts D-E 120D-E.

The hardware accelerators within each cluster are interconnected with one another over an interconnect network, and are connected to the hardware accelerators within another cluster over a data center network through their corresponding hosts. For example, as illustrated in FIG. 1, the hardware accelerator A 110A—hardware accelerator H 110H within cluster 140A are interconnected over interconnect network 111A, while the cluster 140B includes hardware accelerator J 110J—hardware accelerator Z 110Z within cluster 140B are interconnected over interconnect network 111B. In addition, the hosts A-C 120A-C within cluster 140A are connected over a data center network (DCN) 113 to the hosts D-E 120D-E within cluster 140B. For example, the interconnect network 111A or 111B can be an Inter-Core Interconnect (ICI) network, while the data center network 113 can be an Ethernet network.

Each cluster runs a respective scheduler, e.g., scheduler A 130A for cluster 140A and scheduler B 130B for cluster B 140B, that schedules the computations assigned to the cluster across the accelerators and hosts in the cluster. Each scheduler can be configured to receive a portion of the machine learning workload and assign operations to the hardware accelerators that are included in the same cluster as the scheduler. When the computations assigned to a given cluster are regular, the scheduler for the cluster schedules the computation using parallel asynchronous dispatch.

In some implementations, the respective scheduler for each cluster is a single scheduler that directly schedules each operation on a given device. In other implementations, the respective scheduler is a collective of schedulers that implement a hierarchical scheduling scheme.

The scheduler is configured to schedule the computations assigned to the cluster across the accelerators and hosts in the cluster within strict timing requirements, e.g., at a timescale of milliseconds, in order to achieve normal operation of the system. In some implementations, the scheduler can simply enqueue the executions of the portions of the machine learning workload 104 in first-in, first-out (FIFO) order, while in some other implementations, the scheduler can adopt a more sophisticated scheduling algorithm, for example reordering computations based on estimated execution times.

At a high level, this architecture of the system 100 as described above provides the capabilities needed to support a wide range of machine learning workloads, and in particular the capability to support distributed, parallel processing during the training of large-scale neural networks. The distribution can either partition the large amounts of training data into different subsets, partition a very large neural network into smaller subnetworks each having a subset of the parameters of the neural network, or both. The first type of partition may be referred to as data parallelism, while the second may be referred to as model parallelism. The partitioned training data and parameters of the neural network are put onto different hardware accelerators to compute concurrently.

In particular, the system 100 has the capability to support a particular pattern for combining data and model parallelism to achieve the highest performance. As illustrated in FIG. 1, when the hardware accelerators and their corresponding hosts are partitioned into multiple clusters, the system 100 can adopt data parallelism across these clusters, e.g., cluster A 140A and cluster B 140B, and can additionally adopt model parallelism across the hardware accelerators within each cluster. For example models with hundreds of billions of weight parameters, a huge amount of compute resources and communications can thus be saved to converge the model to the level of accuracy required.

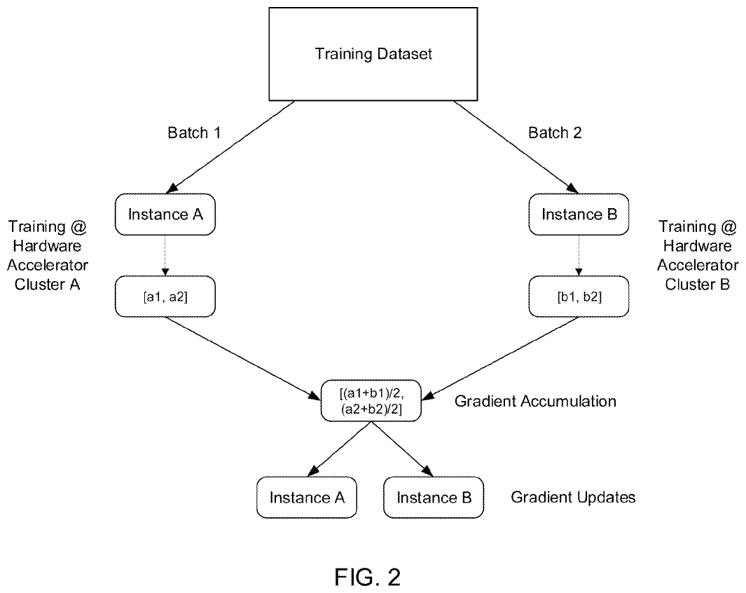

FIG. 2 is an example illustration of training a machine learning model on multiple clusters of hardware accelerators using data and model parallelism. As mentioned above, the system 100 adopts model parallelism within each cluster. FIG. 2 thus illustrates two identical instances (or replicas) of the machine learning model A and B each being trained on a corresponding cluster of hardware accelerators. For example, machine learning model instance A is trained on cluster 140A, while machine learning model instance B is trained on the cluster 140B of FIG. 1.

When trained, a machine learning model is defined by values of the parameters of the model. The parameters are generally organized as non-scalar data, e.g., as a vector, a two-dimensional (2D) matrix, a three-dimensional (3D) matrix, or a matrix of higher degree, whose elements are generally scalar values, e.g., integers or floating point numbers. Thus training a machine learning model instance on a cluster generally requires storing a copy of all parameters of the machine learning model across the hardware accelerators within the cluster.

Within each cluster, which includes multiple different hardware accelerators, the system 100 can employ any suitable model parallelism technique to partition (the parameters of) the machine learning model instance into smaller sub-models across the multiple hardware accelerators, e.g., to avoid exceeding the available memory of the hardware accelerators.

Because the system 100 adopts data parallelism across these two clusters, at each iteration of the training process, the instance of the machine learning model trained on each cluster is configured to process a unique batch of training data, e.g., from a training dataset. In FIG. 2, machine learning model instances A and B are configured to process batches 1 and 2, respectively. When a cluster has finished processing its batch of training data, the cluster has a respective set of gradients for the values of the parameters.

The set of gradients define the local updates to the values of the parameters of machine learning model instance stored across the hardware accelerators within the cluster. The set of gradients can be determined using one or more gradient descent techniques, including for example stochastic gradient descent techniques, Adafactor techniques, Adam techniques, and their derivations or other gradient descent techniques.

Moreover, the set of gradients can be computed based on the parameters stored across the multiple hardware accelerators within the cluster, in accordance with the actual model parallelism technique adopted by the system 100. Generally, under model parallelism, the batch of training data is replicated across each of multiple hardware accelerators within the cluster, with each hardware accelerator executing different operations of a machine learning model, e.g., different operations of different layers of a neural network, on copies of the same data. Thus, during the forward propagation, each hardware accelerator within a cluster takes model activation input from its local training data, or from the output of another hardware accelerator that operates on hidden layers before itself. The hardware accelerator then computes the activation output, which can either be a final model output, or serve as the activation input of another hardware accelerator. During the backward propagation, the gradients are computed on the hardware accelerator(s) that include the final layer, and get sent to other hardware accelerators within the cluster that include the previous layers to compute the gradients for these other layers of the machine learning model instance.

In the example of FIG. 2, when clusters A and B have finished processing batches 1 and 2, respectively, cluster A and cluster B have gradient values [a1, a2] and [b1, b2], respectively. The structure of the gradient values in each cluster is the same and generally corresponds to the structure of the parameters of the machine learning model. For convenience, these are referred to as gradient vectors. Although each such gradient vector is depicted in FIG. 2 as having two values, in general a gradient vector can have many more values, usually orders of magnitude more values.

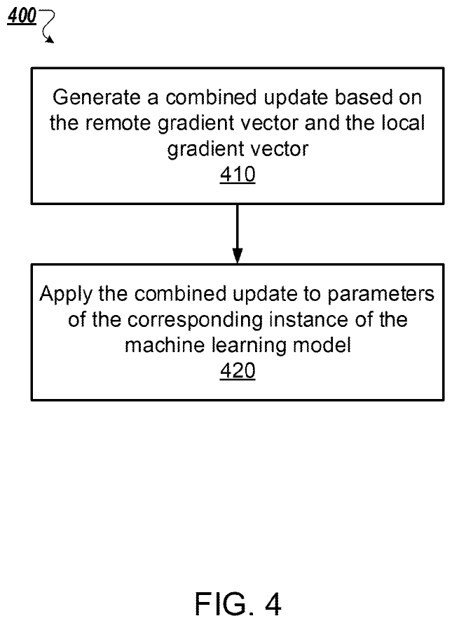

Because the two machine learning model instances A and B are trained on different training data, the gradient vectors held by the two clusters are combined to generate a final gradient vector, which is used to update the parameter values of each instance of the machine learning model. One way to combine the gradient vectors is to generate an element-wise average, which gives a final gradient vector in the form of [(a1+b1)/2, (a2+b2)/2], as illustrated in FIG. 2. It will be appreciated that there are other ways to combine the gradient vectors. Once combined, the final gradient vector is then communicated across all hardware accelerators within each cluster to update the parameter values of the machine learning model instance stored thereon in accordance with any of a variety of update rules, as will be described below with reference to FIG. 4.

Each cluster of hardware accelerators can communicate the gradient vector to another cluster of hardware accelerators by using its corresponding hosts and over the data center network. For example, in FIG. 1, cluster A 140A can use hosts A-C 120 A-C connected to the hardware accelerators A-H 110A-110H included in the cluster to communicate the gradient vector over the data center network 113 to hosts D-E 120D-E connected to the hardware accelerators J-Z 110J-110Z.

Under data parallelism, the multiple clusters exchange the same amount of gradient vectors with each other at each iteration of the training process. Communication throughput thus becomes more important in data parallelism. For example, for models with hundreds of billions of weight parameters, the total data sent and received by each host at the end of each iteration of the training process may be on the scale of a few gigabytes, or more. Continual exchange or communication between the hosts across multiple clusters may increase cost of transmitting gradient vectors and burden to the data center network bandwidth.

To alleviate this issue, a one-to-one communication is performed between the corresponding hosts of multiple clusters of hardware accelerators. Thus, in FIG. 1, at the end of each iteration of the training process, each host of a first cluster, e.g., host A 120 A of cluster A 140A, exchanges a respective portion of the gradient vector with a corresponding host of a second cluster, e.g., host D 120D of cluster B 140B, in parallel with other pairs of hosts across different clusters. The respective portion of the gradient vector held by each host of a given cluster can be a respective subset of the gradient vector generated as a result of the computation during the training iteration across the plurality of hardware accelerators within the given cluster. For example, each host can hold a respective portion, i.e., a respective sub-vector, of the gradient vector that includes the gradients for a subset of the parameters of the machine learning model.

In the one-to-one communication pattern, and unlike in a one-to-many communication pattern where a host of a given cluster simultaneously communicates its portion of the gradient vector with two or more other hosts of different cluster(s), the host of the given cluster communicates its portion of the gradient vector to just one other host at a time point.

A variety of techniques can be used to achieve increased bandwidth usage of the data center network. For example, data representing the gradient vectors can be divided into packets and routed as multiple smaller flows over the data center network to mitigate the effects of congestion. Moreover, a variety of techniques can be used to ensure data integrity of the data that is being transmitted over the data center network. For example, checksum integrity verification techniques, e.g., MD5 and SHA checksum algorithms and their variants, can be used check the data representing the gradient vectors upon receipt and/or transmission to provide protection against silent data corruption.

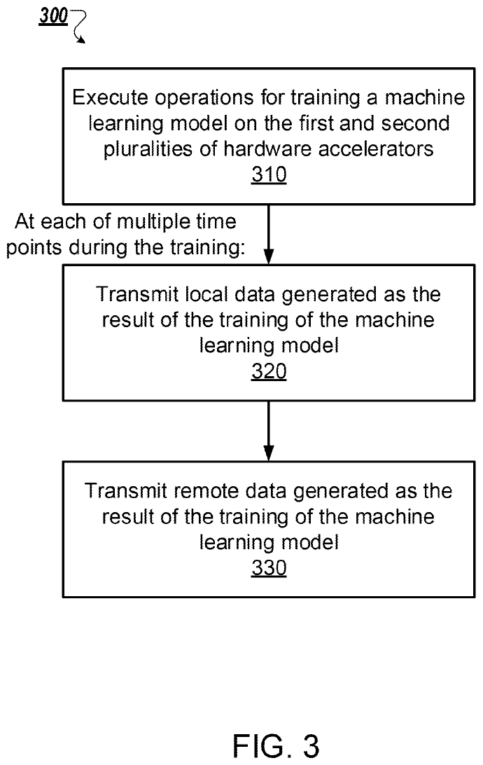

FIG. 3 is a flow diagram of an example process 300 for training a machine learning model on multiple clusters of hardware accelerators. For convenience, the process 300 will be described as being performed by a system of one or more computers located in one or more locations. For example, a system, e.g., the system 100 of FIG. 1, appropriately programmed in accordance with this specification, can perform the process 300.

The system maintains data partitioning hardware accelerators and their corresponding hosts into multiple clusters. Each cluster includes a plurality of accelerators and their corresponding hosts. In some implementations, all of the accelerators are the same type of accelerator while in other implementations different clusters can include different types of accelerators or a single cluster can include multiple different types of accelerators. In some implementations, the partitioning is static while, in other implementations, the system dynamically adjusts the partitioning based on the current system workload.

For example, the system can maintain data that partitions the hardware accelerators and their corresponding hosts into a first cluster and a second cluster. The first cluster includes a first plurality of hardware accelerators that are interconnected over a first network and one or more corresponding hosts for the first plurality of hardware accelerators. The second cluster includes a second plurality of hardware accelerators that are interconnected over a second network and one or more corresponding hosts for the second plurality of hardware accelerators. For example, the first and second networks can each be a respective Inter-Core Interconnect (ICI) network. The corresponding hosts for the first and second pluralities of hardware accelerators are connected over a third network, which can for example be a data center network, e.g., an Ethernet network.

The system can generally perform process 300 in response to receiving data representing a machine learning workload that includes computations for training a machine learning model. In some cases, the system can receive the data from a client over a data communication network. In some cases, the data representing the machine learning workload includes data representing a dataflow program. An example dataflow program for training a machine learning model typically includes: (i) a first component for generating the respective local gradient vectors, (ii) a transfer subgraph for transmitting the respective local gradient vectors and receiving the respective remote gradient vectors, and (iii) a second component for applying the combined update. Dataflow programs are described in more details in U.S. Pat. No. 11,556,381B2, which is incorporated by reference herein in its entirety.

The system executes operations for training a machine learning model on the first and second pluralities of hardware accelerators (step 310). The operations can include operations for applying a first batch of training data to train a corresponding instance of the machine learning model across the first plurality of hardware accelerators and applying a second batch of training data to train a corresponding instance of the machine learning model across the second plurality of hardware accelerators.

Each hardware accelerator of the first plurality of hardware accelerators is configured to use the first network to exchange local data generated as a result of the training of the machine learning model on the hardware accelerator with other hardware accelerators of the first plurality of hardware accelerators. Under model parallelism, the local data that gets sent around the first network interconnecting the first plurality of hardware accelerators can include intermediate activation outputs of the machine learning model (during forward propagation), as well as the gradients at the model partitioning boundaries (during backward propagation).

Likewise, each hardware accelerator of the second plurality of hardware accelerators is configured to use the second network to exchange remote data generated as a result of the training of the machine learning model on the hardware accelerator with other hardware accelerators of the second plurality of hardware accelerators. Note that here “local” and “remote,” as well as “source” and “destination” are defined from the perspective of the first plurality of hardware accelerators.

At each of multiple time points during the training (e.g., at the end of each iteration of the training process), the system transmits local data generated as the result of the training of the machine learning model since a previous time point (e.g., during each iteration) across the first plurality of hardware accelerators to the second plurality of hardware accelerators over the third network (step 320).

Under data parallelism, the local data that gets sent over the third network can include a local gradient vector resulting from the training held by the one or more source hosts for the first plurality of hardware accelerators. The local gradient vector defines the local updates to the values of the parameters of corresponding instance of machine learning model trained across the first plurality of hardware accelerators. For example, each source host can hold a respective portion of the local gradient vector that includes the gradients for a subset of the parameters of the machine learning model.

During transmission of the local data to the second plurality of hardware accelerators over the third network, each of the one or more source hosts for the first plurality of hardware accelerators transmits its respective portion of the local gradient vector to a corresponding destination host for the second plurality of hardware accelerators over the third network. In particular, each source host for the first plurality of hardware accelerators transmits its respective portion of the local gradient vector to no more than one destination host for the second plurality of hardware accelerators.

Moreover, at each of the multiple time points during the training, the system transmits remote data generated as the result of the training of the machine learning model since the previous time point across the second plurality of hardware accelerators to the first plurality of hardware accelerators over the third network (step 330).

Similarly, under data parallelism, the remote data that gets sent over the third network can include a remote gradient vector resulting from the training held by each of the one or more destination hosts for the second plurality of hardware accelerators. The remote gradient vector defines the remote updates to the values of the parameters of corresponding instance of machine learning model trained across the second plurality of hardware accelerators. For example, each destination host can hold a respective portion of the remote gradient vector.

During transmission of the remote data to the first plurality of hardware accelerators over the third network, each of the one or more source hosts for the first plurality of hardware accelerators receives a respective portion of the remote gradient vector held by the corresponding destination host for the second plurality of hardware accelerators over the third network. In particular, each source host for the first plurality of hardware accelerators receives a respective portion of the remote gradient vector from no more than one destination host for the second plurality of hardware accelerators.

In the example where each source host holds a respective sub-vector of the local gradient vector that includes the gradients for a subset of the parameters of the machine learning model, a source host can receive, from a corresponding destination host, a respective sub-vector of the remote gradient vector that includes the gradients for the same subset of the parameters of the machine learning model. After all source hosts for the first plurality of hardware accelerators receives the respective portions of the remote gradient vector from their corresponding destination hosts, the parameters of the machine learning model can then be updated.

FIG. 4 is a flow diagram of an example process 400 for updating parameters of a machine learning model during the training. For convenience, the process 400 will be described as being performed by a system of one or more computers located in one or more locations. For example, a system, e.g., the system 100 of FIG. 1, appropriately programmed in accordance with this specification, can perform the process 400. Process 400 can be performed at each of multiple time points during the training, e.g., at the end of each iteration of the training process after the local/remote gradient exchange.

The system generates, at the first plurality of hardware accelerators, one or more combined updates based on the respective portions of the remote gradient vector and the respective portions of the local gradient vectors (step 410). Each combined update can be in the form of a final, globally consistent gradient vector, with which the same subset of the parameters of both instances of the machine learning model are updated at the end of each iteration.

In some implementations, the system can generate a combined update for each source host based on computing an element-wise average of the respective sub-vector of the remote gradient vector (received from the corresponding destination host over the third network) and the respective sub-vector of the local gradient vector (held by source host). For each source host, the system can then communicate the combined update over the first interconnect network to the corresponding hardware accelerators among the first plurality of hardware accelerators that share the source host, in order to update the subset of the model parameter stored thereon.

The system applies, at the first plurality of hardware accelerators, the one or more combined updates to parameters of the corresponding instance of the machine learning model (step 420). The first plurality of hardware accelerators generally combine the final gradient vectors with the values of the machine learning model parameters to produce an updated set of parameter values.

For example, assuming a vector of current parameters θₜ₋₁ (before the current training iteration) and the gradient vector gₜ (computed at the current training iteration), a vector of updated parameters et (after the current training iteration) can be computed using the following equations:
mₜ←β₁·mₜ₋₁+(1−β₁)·gₜ (Update biased first moment estimate)
vₜ←β₂·vₜ₋₁+(1−β₂)·gₜ² (Update biased second raw moment estimate)
\hat{m}ₜ←mᵢ/(1−β₁^{t}) (Compute bias-corrected first moment estimate)
\hat{v}ₜ←vᵢ/(1−β₂^{t}) (Compute bias-corrected second raw moment estimate)+
θₜ←θₜ₋₁−α·\hat{m}ₜ/(\sqrt{\hat{v}ₜ}+ϵ) (Update parameters)
   where m and v are moment vectors which may be initialized to zero prior to the commencement of the training, a is the learning rate, β₁ and β₂ are exponential decay rates, and e is a (very small) number to prevent any division by zero. In other examples, the update rules can be arbitrarily complicated, e.g., they can depend on previous gradients, depend on different learning rates and/or exponential decay rates, and so on.

Moreover, the system can use any one of the scalability techniques described in Section 3 of Kumar, Sameer, et al. “Exploring the limits of Concurrency in ML Training on Google TPUs.” Proceedings of Machine Learning and Systems 3 (2021): 81-92, the entire contents of which are incorporated by reference herein, to reduce communication latency or overhead or both, and thereby improve the efficiency when updating the parameters of the machine learning model during the training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A system comprising:
a first plurality of hardware accelerators that are interconnected over a first network and one or more corresponding hosts for the first plurality of hardware accelerators; and
a second plurality of hardware accelerators that are interconnected over a second network and one or more corresponding hosts for the second plurality of hardware accelerators, wherein the corresponding hosts for the first and second pluralities of hardware accelerators are connected over a third network, and wherein the system is configured to:
execute operations for training a machine learning model on the first and second pluralities of hardware accelerators, wherein each hardware accelerator of the first plurality of hardware accelerators is configured to use the first network to exchange local data generated as a result of the training of the machine learning model on the hardware accelerator with other hardware accelerators of the first plurality of hardware accelerators; and
at each of multiple time points during the training:
transmit local data generated as the result of the training of the machine learning model since a previous time point across the first plurality of hardware accelerators to the second plurality of hardware accelerators over the third network.

2. The system of claim 1, wherein the system is configured to, at each of the multiple time points during the training:
transmit remote data generated as the result of the training of the machine learning model since the previous time point across the second plurality of hardware accelerators to the first plurality of hardware accelerators over the third network.

3. The system of claim 1, wherein the first and second network are each a respective Inter-Core Interconnect (ICI) network that is different than the third network.

4. The system of claim 1, wherein the third network is a data center network, comprising an Ethernet network.

5. The system of claim 1, wherein:
executing the operations for training the machine learning model comprises training a corresponding instance of the machine learning model across the first plurality of hardware accelerators and training a corresponding instance of the machine learning model across the second plurality of hardware accelerators,
the local data generated as the result of the training of the machine learning model since the previous time point comprises a local gradient vector resulting from the training held by the one or more corresponding hosts for the first plurality of hardware accelerators, and
the remote data generated as the result of the training of the machine learning model since the previous time point comprises a remote gradient vector resulting from the training held by the one or more corresponding hosts for the second plurality of hardware accelerators.

6. The system of claim 5, wherein transmitting the local data to the second plurality of hardware accelerators over the third network comprises:
transmitting, by each of the one or more corresponding hosts for the first plurality of hardware accelerators, a respective portion of the local gradient vector held by the host to a corresponding host for the second plurality of hardware accelerators over the third network.

7. The system of claim 5, wherein transmitting the respective remote data to the first plurality of hardware accelerators over the third network further comprises:
receiving, by each of the one or more corresponding hosts for the first plurality of hardware accelerators, a respective portion of the remote gradient vector held by the corresponding host for the second plurality of hardware accelerators over the third network.

8. The system of claim 1, wherein the first plurality of hardware accelerators are configured to, at each of the multiple time points during the training:
generate one or more combined updates based on the respective remote gradient vectors and the respective local gradient vectors; and
apply the one or more combined updates to parameters of the corresponding instance of the machine learning model.

9. The system of claim 1, wherein the system further comprises a respective scheduler for the first or second plurality of hardware accelerators that is configured to schedule workloads across the plurality of accelerators and the corresponding hosts in accordance with received data representing a machine learning workload for training the machine learning model.

10. The system of claim 9, wherein the data representing the machine learning workload for training the machine learning model comprises a dataflow program that includes:
a first component for generating the respective local gradient vectors,
a transfer subgraph for transmitting the respective local gradient vectors and receiving the respective remote gradient vectors, and
a second component for applying the combined update.

11. The system of claim 1, wherein the system is configured to transmit and receive the respective local data using checksum integrity verification techniques to provide protection against silent data corruption.

12. One or more non-transitory computer-readable storage media storing instructions that when executed by one or more computers cause the one or more computers to perform operations comprising:
executing operations for training a machine learning model on a first plurality of hardware accelerators and a second plurality of hardware accelerators, wherein:
the first plurality of hardware accelerators are interconnected over a first network and have one or more corresponding hosts,
the second plurality of hardware accelerators are interconnected over a second network and have one or more corresponding hosts,
the corresponding hosts for the first and second pluralities of hardware accelerators are connected over a third network, and
each hardware accelerator of the first plurality of hardware accelerators is configured to use the first network to exchange local data generated as a result of the training of the machine learning model on the hardware accelerator with other hardware accelerators of the first plurality of hardware accelerators; and
at each of multiple time points during the training:
transmitting local data generated as the result of the training of the machine learning model since a previous time point across the first plurality of hardware accelerators to the second plurality of hardware accelerators over the third network.

13. A method performed by one or more computers, the method comprising:
executing operations for training a machine learning model on a first plurality of hardware accelerators and a second plurality of hardware accelerators, wherein:
the first plurality of hardware accelerators are interconnected over a first network and have one or more corresponding hosts,
the second plurality of hardware accelerators are interconnected over a second network and have one or more corresponding hosts,
the corresponding hosts for the first and second pluralities of hardware accelerators are connected over a third network, and
each hardware accelerator of the first plurality of hardware accelerators is configured to use the first network to exchange local data generated as a result of the training of the machine learning model on the hardware accelerator with other hardware accelerators of the first plurality of hardware accelerators; and
at each of multiple time points during the training:
transmitting local data generated as the result of the training of the machine learning model since a previous time point across the first plurality of hardware accelerators to the second plurality of hardware accelerators over the third network.

14. (canceled)

15. (canceled)

16. The method of claim 13, further comprising, at each of the multiple time points during the training:
transmitting remote data generated as the result of the training of the machine learning model since the previous time point across the second plurality of hardware accelerators to the first plurality of hardware accelerators over the third network.

17. The method of claim 13, wherein the first and second network are each a respective Inter-Core Interconnect (ICI) network that is different than the third network.

18. The method of claim 13, wherein the third network is a data center network, comprising an Ethernet network.

19. The method of claim 13, wherein:
executing the operations for training the machine learning model comprises training a corresponding instance of the machine learning model across the first plurality of hardware accelerators and training a corresponding instance of the machine learning model across the second plurality of hardware accelerators,
the local data generated as the result of the training of the machine learning model since the previous time point comprises a local gradient vector resulting from the training held by the one or more corresponding hosts for the first plurality of hardware accelerators, and the remote data generated as the result of the training of the machine learning model since the previous time point comprises a remote gradient vector resulting from the training held by the one or more corresponding hosts for the second plurality of hardware accelerators.

20. The method of claim 19, wherein transmitting the local data to the second plurality of hardware accelerators over the third network comprises:
transmitting, by each of the one or more corresponding hosts for the first plurality of hardware accelerators, a respective portion of the local gradient vector held by the host to a corresponding host for the second plurality of hardware accelerators over the third network.

21. The method of claim 19, wherein transmitting the respective remote data to the first plurality of hardware accelerators over the third network further comprises:
receiving, by each of the one or more corresponding hosts for the first plurality of hardware accelerators, a respective portion of the remote gradient vector held by the corresponding host for the second plurality of hardware accelerators over the third network.

22. The method of claim 13, wherein the first plurality of hardware accelerators are configured to, at each of the multiple time points during the training:
generate one or more combined updates based on the respective remote gradient vectors and the respective local gradient vectors; and
apply the one or more combined updates to parameters of the corresponding instance of the machine learning model.
